(19) United States
(12) Patent Application Publication
(10) Pub. No.: US 2004/0255154 A1
(43) Pub. Date: Dec. 16, 2004

(54) Multiple tiered network security system, method and apparatus

(75) Inventors: Philip Kwan, San Jose, CA (US); Chi-Jui Ho, Campbell, CA (US)

Correspondence Address: David B. Ritchie, Thelen Reid & Priest LLP, P.O. Box 640640, San Jose, CA, 95164-0640, US

(73) Assignee: Foundry Networks, Inc.

(21) Appl. No.: 10/458,628

(22) Filed: Jun. 11, 2003

(51) Int. Cl. H04L 9/00

(52) U.S. Cl. 713/201

(57) ABSTRACT

A multiple key, multiple tiered network security system, method and apparatus provides at least three levels of security. The first level of security includes physical MAC address authentication of a device being attached to the network, such as a device being attached to a port of a network switch. The second level includes authentication of the user of the device, such as user authentication in accordance with the 802.1x standard. The third level includes dynamic assignment of the port to a particular VLAN based on the identity of the user. Failure to pass a lower security level results in a denial of access to subsequent levels of authentication.

### BACKGROUND OF THE INVENTION

1. Field of the Invention

The present invention is generally directed to data communications networks. In particular, the present invention is directed to security features for controlling access to a data communications network.

2. Background

There is an increasing demand for additional security features for controlling access to data communications networks. This is due, in large part, to an increase in the use of portable computing devices such as laptop computers and Voice Over Internet Protocol (VOIP) telephones, which can be easily moved from one point of network access to another. While such ease of access may be desirable from an end user perspective, it creates significant concerns from the perspective of network security.

For wired networks, recent security solutions from network vendors have involved pushing authentication functions out to the layer 2 port, such as to a layer 2 switch. One such solution involves authenticating the physical, or Media Access Control (MAC), address of a device coupled to the port of a layer 2 switch. Another solution involves enabling the switch to perform user authentication in accordance with protocols defined by the IEEE 802.1x standard. A further solution builds on the 802.1x protocol to dynamically assign the user to a Virtual Local Area Network or “VLAN” (as defined in accordance with the IEEE 802.1q standard) based on their identity, wherein the assignment to a particular VLAN may be premised on security considerations. However, a majority of conventional switches do not provide the ability to implement all of these security features in a single network device.

A product marketed by Cisco Systems, Inc. of San Jose, Calif., designated the Catalyst 3550 Multilayer Switch, apparently provides a combination of the foregoing security features. However, the combination of features is only provided in a multiple host (“multi-host”) configuration, in which one or more computing devices are coupled to a single port of the switch via a central computing device. Furthermore, the 802.1x authentication is always performed prior to physical (MAC) address authentication in the Cisco product. Thus, when a computing device is coupled to a port of the Cisco switch, local resources (e.g., switch resources necessary to perform 802.1x authentication and, optionally, dynamic VLAN assignment) as well as network resources (e.g., communication between the switch and an authentication server) will always be expended to authenticate the user, prior to determining whether or not the physical (MAC) address of the device is valid. This results in a waste of such resources in the case where the device has an unauthorized MAC address.

What is needed then is a security solution that improves upon and addresses the shortcomings of known security solutions.

### BRIEF SUMMARY OF THE INVENTION

The present invention is directed to a network security system, method and apparatus that substantially obviates one or more of the problems and disadvantages of the related art.

In particular, the present invention is directed to a network device, such as a network switch, that implements a multiple key, multiple tiered system and method for controlling access to a data communications network in both a single host and multi-host environment. The system and method provide a first level of security that comprises authentication of the physical (MAC) address of a user device coupled to a port of the network device, such as a network switch, a second level of security that comprises authentication of a user of the user device if the first level of security is passed, such as authentication in accordance with the IEEE 802.1x standard, and a third level of security that comprises dynamic assignment of the port to a particular VLAN based on the identity of the user if the second level of security is passed.

The present invention provides improved network security as compared to conventional solutions, since it authenticates both the user device and the user. Moreover, the present invention provides network security in a manner more efficient than conventional solutions, since it performs physical (MAC) address authentication of a user device prior to performing the more resource-intensive step of performing user authentication, such as user authentication in accordance with a protocol defined by the IEEE 802.1x standard.

In accordance with one embodiment of the present invention, an apparatus for providing network security is provided. The apparatus includes a plurality of input ports and a switching fabric for routing data received on the plurality of input ports to at least one output port. The apparatus also includes control logic adapted to authenticate a physical address of a device coupled to one of the plurality of input ports and to authenticate user information provided by a user of the device only if the physical address is valid. Additionally, the control logic may be further adapted to assign the particular input port to a virtual local area network (VLAN) associated with the user information if the user information is valid. In an embodiment, the particular input port is assigned to the VLAN only if the apparatus is configured to support the specified VLAN.

In an alternate embodiment of the present invention, a method for providing network security is provided. The method includes authenticating a physical address of a device coupled to a port of a network switch, and authenticating user information provided by a user of the device only if the physical address is valid. The method may additionally include assigning the port to a virtual local area network (VLAN) associated with the user information only if the user information is valid. In an embodiment, the method further includes assigning the port only if the switch is configured to support the specified VLAN.

In another embodiment of the present invention, a multiple tiered network security system is provided. The system includes a data communications network, a network switch coupled to the data communications network, and a user device coupled to a port of the network switch. The network switch is adapted to authenticate a physical address of the user device and to authenticate user information provided by a user of the user device only if the physical address is valid. Additionally, the network switch may be further adapted to assign the port to a virtual local area network (VLAN) associated with the user information only if the user information is valid. In an embodiment, the network switch only assigns the port if the switch is configured to support the specified VLAN.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts the basic elements of a multiple tiered network security system in accordance with an embodiment of the present invention.

FIG. 2 depicts an exemplary high-level architecture of a network switch in accordance with an embodiment of the present invention.

FIG. 3 illustrates a flowchart of a multiple tiered network security method in accordance with an embodiment of the present invention.

FIG. 4 illustrates a flowchart of a method for enabling physical address authentication of a device coupled to a data communications network in accordance with an embodiment of the present invention.

FIG. 5 illustrates a flowchart of a method for performing user authentication and dynamic VLAN assignment in accordance with an embodiment of the present invention.

FIG. 6 depicts a multiple tiered network security system that accommodates a plurality of user devices in a multi-host configuration in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION OF THE INVENTION

A. Overview

The present invention is directed to a multiple key, multiple tiered network security system, method and apparatus. The system, method and apparatus provides at least three levels of security. The first level comprises physical MAC address authentication of a device being attached to a network, such as a device being coupled to a port of a network switch. The second level comprises authentication of the user of the device, such as authentication in accordance with the IEEE 802.1x standard. The third level comprises dynamic assignment of the port to a particular VLAN based on the identity of the user. Failure to pass a lower security level results in a denial of access to subsequent levels of authentication.

B. Multiple Tiered Security System, Method and Apparatus in

Accordance with an Embodiment of the Present Invention

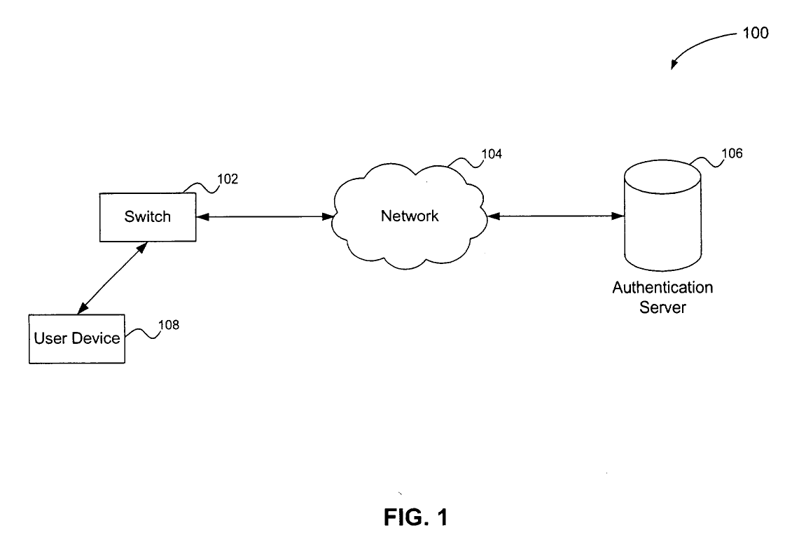

FIG. 1 depicts the basic elements of a multiple tiered network security system 100 in accordance with an embodiment of the present invention. As shown in FIG. 1, system 100 comprises a data communications network 104, a network switch 102 and an authentication server 106 each of which is communicatively coupled to data communications network 104, and a user device 108 communicatively coupled to network switch 102.

Data communications network 104 comprises a plurality of network nodes interconnected via a wired and/or wireless medium, wherein each node consists of a device capable of transmitting or receiving data over data communications network 104. In the embodiment described herein, data communications network 104 comprises a conventional local area network (“LAN”) that employs an Ethernet communication protocol in accordance with the IEEE 802.3 standard for data link and physical layer functions. However, the invention is not so limited, and data communications network 104 may comprise other types of networks, including but not limited to a wide area network (“WAN”), and other types of communication protocols, including but not limited to ATM, token ring, ARCNET, or FDDI (Fiber Distributed Data Interface) protocols.

Network switch 102 is a device that comprises a plurality of ports for communicatively interconnecting network devices to each other and to data communications network 104. Network switch 102 is configured to channel data units, such as data packets or frames, between any two devices that are attached to it up to its maximum number of ports. In terms of the International Standards Organization's Open Systems Interconnection (OSI) model, network switch 102 performs layer 2, or data link layer, functions. In particular, network switch 102 examines each received data unit and, based on a destination address included therein, determines which network device the data unit is intended for and switches it out toward that device. In the embodiment described herein, the destination address comprises a physical or Media Access Control (MAC) address of a destination device.

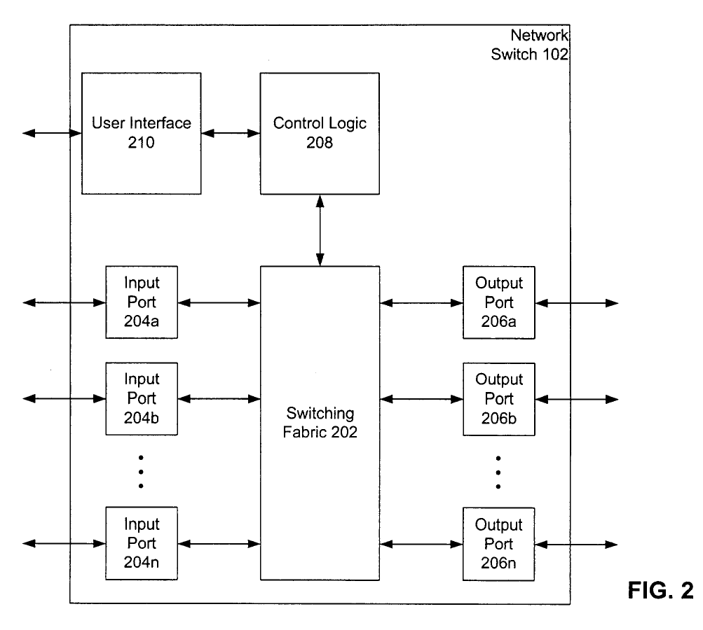

FIG. 2 depicts an exemplary high-level architecture of network switch 102 in accordance with an embodiment of the present invention. As shown in FIG. 2, network switch 102 comprises a plurality of input ports, 204a through 204n, that are coupled to a plurality of output ports, 206a through 206n, via a switching fabric 202. Network switch 102 also includes control logic 208 for controlling various aspects of switch operation and a user interface 210 to facilitate communication with control logic 208. User interface 210 provides a means for a user, such as a system administrator, to reconfigure the switch and adjust operating parameters.

In operation, data units (e.g, packets or frames) are received and optionally buffered on one or more of input ports 204a through 204n. Control logic 208 schedules the serving of data units received by input ports 204a through 204n in accordance with a predetermined scheduling algorithm. Data units are then served to switching fabric 202, which routes them to the appropriate output port 206a through 206n based on, for example, the destination address of the data unit. Output ports 206a through 206n receive and optionally buffer data units from switching fabric 202, and then transmit them on to a destination device. In accordance with an embodiment of the present invention, network switch 102 may also include logic for performing routing functions (layer 3 or network layer functions in OSI).

With further reference to FIG. 1, a user device 108 is shown connected to one of the ports of network switch 102. User device 108 may comprise a personal computer (PC), laptop computer, Voice Over Internet Protocol (VOIP) phone, or any other device capable of transmitting or receiving data over a data communications network, such as data communications network 104. As described in more detail herein, the security features of the present invention are particularly useful in the instance where user device 108 is highly portable, and thus may be readily moved from one point of network access to another.

Authentication server 106 comprises a computer that stores application software and a database of profile information for performing a user authentication protocol that will be described in more detail herein. In an embodiment, authentication server 106 comprises a server that uses the Remote Authentication Dial-In User Service (RADIUS) as set forth in Internet Engineering Task Force (IETF) Request For Comments (RFC) 2865 for performing user authentication functions.

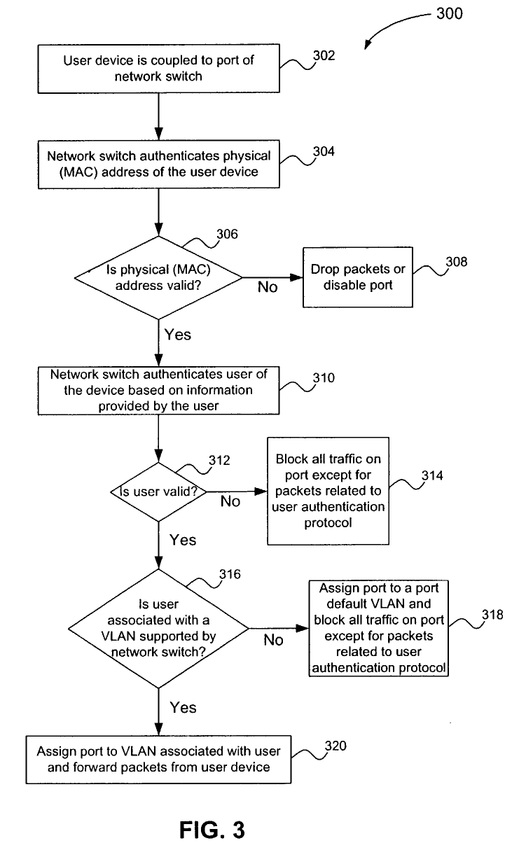

FIG. 3 illustrates a flowchart 300 of a multiple tiered network security method in accordance with an embodiment of the present invention. The invention, however, is not limited to the description provided by the flowchart 300. Rather, it will be apparent to persons skilled in the relevant art(s) from the teachings provided herein that other functional flows are within the scope and spirit of the present invention. Flowchart 300 will be described with continued reference to example system 100 described above in reference to FIG. 1. The invention, however, is not limited to that embodiment.

The method of flowchart 300 begins at step 302, in which user device 108 is coupled to a port of network switch 102. Coupling user device 108 to a port of network switch may comprise, for example, coupling user device 108 to an RJ-45 connector, which is in turn wired to a port of network switch 102.

At step 304, network switch 102 performs a physical (MAC) address authentication of user device 108. As will be described in more detail herein, network switch 102 performs this step by comparing a MAC address of user device 108 with a limited number of “secure” MAC addresses that are stored by network switch 102. As shown at step 306, if packets received from user device 108 have a source MAC address that does not match any of the secure addresses, then the protocol proceeds to step 308, in which network switch 102 either drops the packets or, alternately, disables the port entirely, thereby terminating the security protocol. In a further embodiment of the present invention, network switch 102 can also re-direct the packets to a network destination other than their originally intended destination based on the detection of an invalid source MAC address.

As further shown at step 306, if packets received from user device 108 have a source MAC address that does match one of the secure addresses, then the MAC address is valid and the security protocol proceeds to step 310.

At step 310, network switch 102 authenticates a user of user device 108 based upon credentials provided by the user. As will be discussed in more detail herein, this step entails performing user authentication in accordance with the IEEE 802.1x standard, and involves sending the user credentials in a request message to authentication server 106 and receiving an accept or reject message in return, the accept or reject message indicating whether the user is valid. As shown at step 312, if the user is not valid, then the security protocol proceeds to step 314, in which network switch 102 blocks all traffic on the port except for the reception or transmission of 802.1x control packets on the port. However, as also shown at step 312, if the user is valid, then the security protocol proceeds to step 316.

At step 316, network switch 102 determines whether or not the user is associated with a VLAN supported by the switch. As will be discussed in more detail herein, this step entails determining whether a VLAN identifier (ID) or a VLAN Name was returned as part of the accept message from authentication server 106. If the user is not associated with a VLAN supported by network switch 102, the port to which user device 108 is coupled is (or remains) assigned to a port default VLAN and all traffic on the port is blocked except for the reception or transmission of 802.1x control packets, as shown at step 318. If, however, the user is associated with a VLAN supported by network switch 102, then network switch 102 assigns the port to the specified VLAN and begins processing packets from user device 108, as shown at step 320.

With reference to the exemplary switch embodiment of FIG. 2, the security functions performed by network switch 102, as described above, are performed by control logic 208. As will be appreciated by persons skilled in the art, such functions may be implemented in hardware, software or a combination thereof.

C. Physical Address Authentication of User Device in Accordance with an Embodiment of the Present Invention

As discussed above, network switch 102 is adapted to perform a physical (MAC) address authentication of a user device that is coupled to one of its ports. In particular, network switch 102 is adapted to store a limited number of “secure” MAC addresses for each port. A port will forward only packets with source MAC addresses that match its secure addresses. In an embodiment, the secure MAC addresses are specified manually by a system administrator. In an alternate embodiment, network switch 102 learns the secure MAC addresses automatically. If a port receives a packet having a source MAC address that is different from any of the secure learned addresses, a security violation occurs.

With reference to the embodiment of network switch 102 depicted in FIG. 2, secure addresses for each input port 204a through 204n are stored in a local memory assigned to each port. Alternately, secure addresses are stored in a shared global memory, or in a combination of local and global memory.

In an embodiment, when a security violation occurs, network switch 102 generates an entry to a system log and an SNMP (Simple Network Management Protocol) trap. In addition, network switch 102 takes one of two actions as configured by a system administrator: it either drops packets from the violating address or disables the port altogether for a specified amount of time.

In a further embodiment of the present invention, a system administrator can configure network switch 102 to re-direct packets received from the violating address to a different network destination than that originally intended. Network switch 102 may achieve this by altering the packet headers. For example, network switch 102 may alter a destination address of the packet headers. Alternately, the re-direction may be achieved by generating new packets with identical data payloads but having different packet headers. As will be appreciated by persons skilled in the art, the decision to configure network switch 102 to re-direct traffic from a violating address may be premised on the resulting burden to network switch 102 in handling traffic from that address.

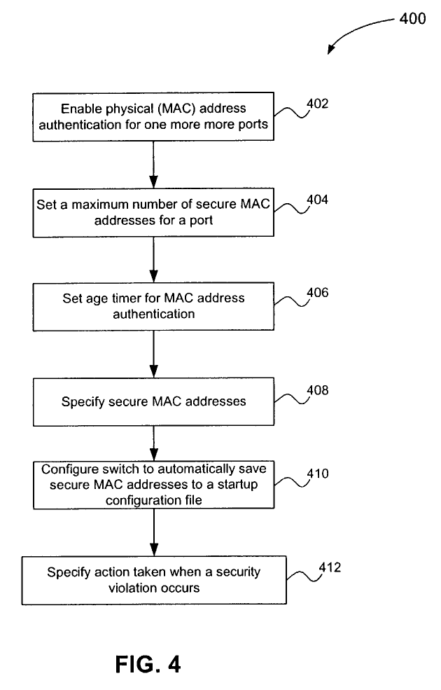

FIG. 4 illustrates a flowchart 400 of a method for enabling physical address authentication of a device coupled to a data communications network in accordance with an embodiment of the present invention. In particular, flowchart 400 represents steps performed by a system administrator in order to configure a network switch to perform physical address authentication in accordance with an embodiment of the invention. The invention, however, is not limited to the description provided by the flowchart 400. Rather, it will be apparent to persons skilled in the relevant art(s) from the teachings provided herein that other functional flows are within the scope and spirit of the present invention.

At step 402, the system administrator enables the MAC address authentication feature for one or more ports of the network switch. In an embodiment, the security feature is disabled on all ports by default, and a system administrator can enable or disable the feature globally on all ports at once or on individual ports.

At step 404, the system administrator sets a maximum number of secure MAC addresses for a port. In an embodiment, the network switch utilizes a concept of local and global “resources” to determine how many MAC addresses can be secured on each port. In this context, “resource” refers to the ability to store one secure MAC address entry. For example, each interface may be allocated 64 local resources and additional global resources may be shared among all the interfaces on the switch.

In an embodiment, when the MAC address authentication feature is enabled for a port, the port can store one secure MAC address by default. A system administrator can then increase the number of MAC addresses that can be secured to a maximum of 64, plus the total number of global resources available. The number of addresses can be set to a number from 0 to (64+the total number of global resources available). For example, the total number of global resources may be 2048 or 4096, depending on the size of the memory allocated. When a port has secured enough MAC addresses to reach its limit for local resources, it can secure additional MAC addresses by using global resources. Global resources are shared among all the ports on a first come, first-served basis.

At step 406, the system administrator sets an age timer for the MAC address authentication feature. In an embodiment, secure MAC addresses are not flushed when a port is disabled and brought up again. Rather, based on how the switch is configured by the system administrator, the secure addresses can be kept secure permanently, or can be configured to age out, at which time they are no longer secure. For example, in an embodiment, the stored MAC addresses stay secure indefinitely by default, and the system administrator can optionally configure the device to age out secure MAC addresses after a specified amount of time.

At step 408, the system administrator specifies secure MAC addresses for a port. Alternately, the switch can be configured to automatically “learn” secure MAC addresses by storing the MAC addresses of devices coupled to the port up to the maximum number of secure addresses for the port. These stored MAC addresses are then used as the secure addresses for authentication purposes.

At step 410, the system administrator optionally configures the switch to automatically save the list of secure MAC addresses to a startup-configuration (“startup-config”) file at specified intervals, thus allowing addresses to be kept secure across system restarts. For example, learned secure MAC addresses can be automatically saved every twenty minutes. The startup-config file is stored in switch memory. In an embodiment, by default, secure MAC addresses are not automatically saved to a startup-config file.

At step 412, the system administrator specifies the action taken when a security violation occurs. In the case where the system administrator has specified the secure MAC addresses for the port, a security violation occurs when the port receives a packet with a source MAC address that is different than any of the secure MAC addresses. In the case where the port is configured to “learn” secure MAC addresses, a security violation occurs when the maximum number of secure MAC addresses has already been reached, and the port receives a packet with a source MAC address that is different than any of the secure MAC addresses. In an embodiment, the system administrator configures the switch to take one of two actions when a security violation occurs: either drop packets from the violating address or disable the port altogether for a specified amount of time.

D. User Authentication and Dynamic VLAN Assignment in Accordance with an Embodiment of the Present Invention

As discussed above, network switch 102 is further adapted to perform user authentication if user device 108 has a valid physical (MAC) address. In an embodiment, user authentication is performed in accordance with the IEEE 802.1x standard. As will be appreciated by persons skilled in the art, the 802.1x standard utilizes the Extensible Authentication Protocol (EAP) for message exchange during the authentication process.

In accordance with 802.1x, a user (known as the supplicant) requests access to a network access point (known as the authenticator). The access point forces the user's client software into an unauthorized state that allows the client to send only an EAP start message. The access point returns an EAP message requesting the user's identity. The client returns the identity, which is then forwarded by the access point to an authentication server, which uses an algorithm to authenticate the user and then returns an accept or reject message back to the access point. Assuming an accept message was received, the access point changes the client's state to authorized and normal communication can take place.

In accordance with the embodiment of the invention described in reference to FIG. 1, and with reference to the 802.1x protocol described above, the user of user device 108 is the supplicant, network switch 102 is the authenticator, and authentication server 106 is the authentication server. In an embodiment, authentication server 106 comprises a server that uses the Remote Authentication Dial-In User Service (RADIUS) as described in RFC 2865, and may therefore be referred to as a RADIUS server.

In further accordance with an embodiment of the present invention, authentication server 106 provides a VLAN identifier (ID) and associated information to network switch 102 as part of the message granting authorization to a particular user. The VLAN ID is included in an access profile for the user, which is configured by a network administrator and maintained in a database by authentication server 106. Network switch 102 is adapted to determine if the VLAN associated with the VLAN ID is available on the switch, and, if so, to dynamically assign the port to which user device 108 is coupled to that particular VLAN.

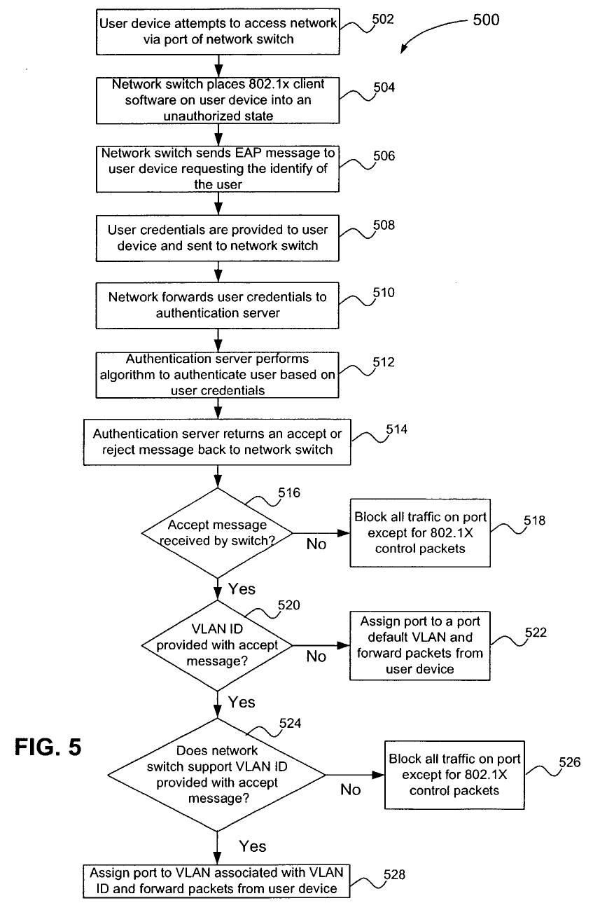

FIG. 5 illustrates a flowchart 500 of a method for performing user authentication and dynamic VLAN assignment in accordance with an embodiment of the present invention. The invention, however, is not limited to the description provided by the flowchart 500. Rather, it will be apparent to persons skilled in the relevant art(s) from the teachings provided herein that other functional flows are within the scope and spirit of the present invention. Flowchart 500 will be described with continued reference to example system 100 described above in reference to FIG. 1. The invention, however, is not limited to that embodiment.

The method of flowchart 500 begins at step 502, in which user device 108 attempts to access data communications network 104 via network switch 102. In response, network switch 102 places 802.1x client software on user device 108 into an unauthorized state that permits the client software to send only an EAP start message, as shown at step 504. Network switch 102 also returns an EAP message to user device 108 requesting the identity of the user, as shown at step 506.

At step 508, the user of user device 108 inputs identity information or credentials, such as a user name and password, into user device 108 that are returned to network switch 102. Network switch 102 then generates an authentication call which forwards the user credentials to authentication server 106, as shown at step 510, and authentication server 106 performs an algorithm to authenticate the user based on the user credentials, as shown at step 512.

At step 514, authentication server 106 returns either an accept or reject message back to network switch 102. As shown at step 516, if authentication server 106 sends a reject message back to network switch 102, the protocol proceeds to step 518. At step 518, network switch 102 blocks all traffic on the port except for the reception or transmission of 802.1x control packets (e.g., EAPOL packets) on the port.

However, if authentication server 106 sends an accept message back to network switch 102, then the protocol proceeds to step 520. At step 520, network switch 102 parses the accept message to determine if a VLAN ID and associated information has been provided for the user. In the embodiment described herein, authentication server 106 provides three tunnel attributes as part of a RADIUS Access-Accept message for dynamic VLAN assignment. The following tunnel attributes are used:

Tunnel-Type=VLAN

Tunnel-Medium-Type=802

Tunnel-Private-Group-ID=VLAN ID

The VLAN ID may comprise 12 bits, taking a value between one and 4094, inclusive. The VLAN ID is included in an access profile for the user, which is configured by a network administrator and maintained in a database by authentication server 106. In an alternate embodiment, a VLAN Name, which comprises a text field, is used instead of a VLAN ID for associating the user with a particular VLAN.

The VLAN assignment controls which nodes the user will have access to on the network (e.g., only nodes that are members of the same VLAN) and is primarily used to differentiate broadcast domains. A VLAN ID may be assigned to a user based on security considerations. For example, a user with a low security clearance may be assigned to a VLAN that has been defined to limit access to information available via data communications network 104.

If a VLAN ID and associated information necessary for dynamic VLAN assignment are not provided with the accept message, network switch 102 assigns the port to a port default VLAN and then accepts packets from user device 108, as shown at step 522.

However, if the appropriate information, including the VLAN ID, is provided, network switch 102 determines if the VLAN ID identifies a valid VLAN for network switch 102, as shown at step 524. In an embodiment, network switch 102 performs this step by comparing the VLAN ID from the accept message with a stored list of valid VLAN IDs for network switch 102.

If network switch 102 does not support the VLAN identified by the VLAN ID, network switch 102 assigns the port to a port default VLAN (or the port remains assigned to the port default VLAN, if already so configured) and all traffic on the port is blocked except for the reception or transmission of 802.1x control packets, as shown at step 526. If network switch 102 does support the VLAN identified by the VLAN ID, then network switch 102 assigns the port to that VLAN and then accepts packets from user device 102 for processing, as shown at step 528. In an embodiment, once a port is assigned to a VLAN, it remains dedicated to the VLAN until such time as a system administrator reassigns the port.

Performing the above-described user authentication protocol after performing physical (MAC) address authentication of user device 108 provides enhanced security when network switch 102 is operating in a mode in which secure MAC addresses can be “learned.” As discussed in Section C, above, network switch 102 can be configured to automatically “learn” secure MAC addresses by storing the MAC addresses of devices coupled to a port up to the maximum number of secure addresses for the port. By necessity, this feature exposes the port to unauthorized devices. Consequently, the subsequent performance of user authentication operates to minimize the security risk associated with this feature.

E. Multiple Tiered Security System, Method and Apparatus for Multi-Host Environments in Accordance with an Embodiment of the Present Invention

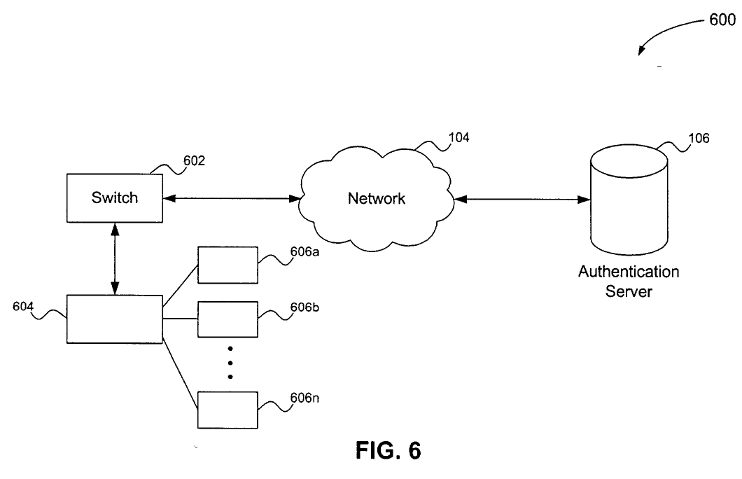

The multiple tiered security protocol described above may be advantageously implemented in both single host and multiple host (multi-host) environments. FIG. 1 depicts a single host environment, as only a single user device 108 is coupled to a port of network switch 102. FIG. 6 depicts an alternate embodiment of the present invention that accommodates a plurality of user devices in a multi-host configuration. In particular, FIG. 6 a multiple tiered network security system 600 that comprises a data communications network 104, a network switch 602 and an authentication server 106 each of which is communicatively coupled to data communications network 104. A central user device 604 is coupled to network switch 602 and a plurality of additional user devices 606a through 606n are coupled to network switch 602 via central user device 604 in a multi-host configuration.

The multiple tiered security protocol described above may be advantageously implemented in system 600 in a variety of ways. For example, network switch 602 may perform physical (MAC) address authentication of central user device 604 only, and then authenticate the users of all the user devices if it determines that central user device 604 has a valid MAC address. If central user device 604 has an invalid MAC address, then the port may be closed to all user devices. Alternately, network switch 602 may perform physical (MAC) address validation of each of the user devices prior to authenticating their users. In this case, network switch 102 can selectively accept packets from user devices having valid MAC addresses while dropping packets from user devices having invalid MAC addresses.

E. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. An apparatus for providing network security, comprising:
a plurality of input ports;
a switching fabric for routing data received on said plurality of input ports to at least one output port; and
control logic adapted to authenticate a physical address of a device coupled to one of said plurality of input ports and to authenticate user information provided by a user of said device only if said physical address is valid.

2. The apparatus of claim 1, wherein said physical address comprises a Media Access Control (MAC) address.

3. The apparatus of claim 1, wherein said control logic is adapted to compare said physical address of said device to at least one secure physical address.

4. The apparatus of claim 1, wherein said control logic is further adapted to disable said one of said plurality of input ports if said physical address is invalid.

5. The apparatus of claim 1, wherein said control logic is further adapted to drop packets from said device if said physical address is invalid.

6. The apparatus of claim 1, wherein said control logic is further adapted to re-direct packets from said device if said physical address is invalid.

7. The apparatus of claim 1, wherein said control logic is adapted to send said user information to an authentication server and receive an accept or reject message from said authentication server in response to sending said user information.

8. The apparatus of claim 7, wherein said authentication server comprises a Remote Authentication Dial-In User Service (RADIUS) server.

9. The apparatus of claim 1, wherein said control logic is further adapted to assign said one of said plurality of input ports to a virtual local area network (VLAN) associated with said user information if said user information is valid.

10. The apparatus of claim 9, wherein said control logic is adapted to receive a message from an authentication server, wherein said message comprises a VLAN identifier (ID) associated with said user information, and to assign said one of said plurality of input ports to a VLAN associated with said VLAN ID.

11. The apparatus of claim 10, wherein said control logic is further adapted to determine if said VLAN is supported by the apparatus.

12. A method for providing network security, comprising:
authenticating a physical address of a device coupled to a port of a network switch; and
authenticating user information provided by a user of said device only if said physical address is valid.

13. The method of claim 12, wherein said authenticating a physical address comprises authenticating a Media Access Control (MAC) address.

14. The method of claim 12, wherein said authenticating a physical address of a device comprises comparing said physical address of said device to at least one secure physical address.

15. The method of claim 12, further comprising:
disabling said port if said physical address is invalid.

16. The method of claim 12, further comprising:
dropping packets from said device if said physical address is invalid.

17. The method of claim 12, further comprising:
re-directing packets from said device if said physical address in invalid.

18. The method of claim 12, wherein said authenticating user information comprises:
sending said user information to an authentication server; and
receiving an accept or reject message from said authentication server in response to said sending said user information.

19. The method of claim 18, wherein said authentication server comprises a Remote Authentication Dial-In User Service (RADIUS) server.

20. The method of claim 12, further comprising:
assigning said port to a virtual local area network (VLAN) associated with said user information only if said user information is valid.

21. The method of claim 20, wherein said assigning said port to a VLAN comprises:
receiving a message from an authentication server, wherein said message comprises a VLAN identifier (ID) associated with said user information;
assigning said port to a VLAN associated with said VLAN ID.

22. The method of claim 21, further comprising:
determining if said VLAN is supported by said network switch.

23. A network system, comprising:
a data communications network;
a network switch coupled to said data communications network; and
a user device coupled to a port of said network switch;
wherein said network switch is adapted to authenticate a physical address of said user device and to authenticate user information provided by a user of said user device only if said physical address is valid.

24. The system of claim 23, wherein said network switch is adapted to authenticate a Media Access Control (MAC) address of said user device.

25. The system of claim 23, wherein said network switch is adapted to compare said physical address of said user device to at least one secure physical address.

26. The system of claim 23, wherein said network switch is further adapted to disable said port if said physical address is invalid.

27. The system of claim 23, wherein said network switch is further adapted to drop packets from said user device if said physical address is invalid.

28. The system of claim 23, wherein said network switch is further adapted to re-direct packets from said user device if said physical address is invalid.

29. The system of claim 23, further comprising:
an authentication server coupled to said data communications network;
wherein said network switch is adapted to send said user information to said authentication server and to receive an accept or reject message from said authentication server in response to sending said user information.

30. The system of claim 29, wherein said authentication server comprises a Remote Authentication Dial-In User Service (RADIUS) server.

31. The system of claim 23, wherein said network switch is further adapted to assign said port to a virtual local area network (VLAN) associated with said user information only if said user information is valid.

32. The system of claim 31, further comprising:
an authentication server coupled to said data communications network;
wherein said network switch is adapted to receive a message from said authentication server, wherein said message comprises a VLAN identifier (ID) associated with said user information, and to assign said port to a VLAN associated with said VLAN ID.

33. The system of claim 32, wherein said network switch is further adapted to determine if said VLAN is supported by said network switch.
